(19) United States
(12) Patent Application Publication
(10) Pub. No.: US 2025/0175081 A1
(43) Pub. Date: May 29, 2025

(54) ENHANCING EFFICIENCY OF A SWITCHING CONVERTER

(71) Applicant: Shaoxing Yuanfang Semiconductor Co., Ltd., Shaoxing (CN)

(72) Inventors: Santosh Nene, Bangalore (IN); Anil Narayan Kakade, Bangalore (IN); Suresh Venkatesan, Bangalore (IN); Ramkishore Ganti, Bangalore (IN); Ramasiddaiah Pamidi, Bangalore (IN); Yugandhar Tannidi, Bangalore (IN)

(21) Appl. No.: 18/942,834

(22) Filed: Nov. 11, 2024

(30) Foreign Application Priority Data
Nov. 24, 2023 (IN) 202341079957

(51) Int. Cl. H02M 3/158; H02M 1/00

(52) U.S. Cl. CPC H02M 3/158; H02M 1/0009; H02M 1/0012

(57) ABSTRACT

A multi-phase switching converter includes multiple power stages and a phase controller. Each power stage is designed to drive a corresponding inductor to cause flow of a corresponding inductor-current according to a respective phase control signal, with the corresponding inductor-currents from each of the power stages together constituting a load-current of the converter. The phase controller is designed to determine a frequency of the phase control signals based on magnitudes of the inductor-currents, and generate the phase control signals with the frequency. In an embodiment, each power stage sends information on the corresponding inductor-current to the phase controller, and the phase controller determines the frequency as an optimal frequency at which the power stages operate with optimal power efficiency. However, the phase controller determines the frequency to be a maximum frequency if at least one of a higher phase-count-demand, undershoot and over-current is detected.

### PRIORITY CLAIM

The instant patent application is related to and claims priority from the co-pending India provisional patent application entitled, “AUTOMATIC EFFICIENCY IMPROVEMENT (AEM) WITH INDUCTOR SATURATION PROTECTION”, Serial No.: 202341079957, Filed: 24 Nov. 2023, Attorney docket no.: AURA-351-INPR, which is incorporated in its entirety herewith to the extent not inconsistent with the description herein.

### BACKGROUND

### Technical Field

Embodiments of the present disclosure relate generally to multi-phase switching converters, and more specifically to enhancing efficiency of the multi-phase switching converters.

### Related Art

Switching converters refer to components which convert an input AC (alternating current) or DC (direct current) voltage of one magnitude to an output DC voltage of a desired magnitude by employing and operating switch(es), as is well known in the relevant arts. Switching converters find use as stand-alone power supplies, in voltage regulator modules used in several environments such as laptops, mobile phones, etc.

A switching converter often employs multiple power stages, which together generate the regulated DC voltage. Each power stage drives a corresponding inductor to cause flow of a corresponding inductor-current in a respective phase of a sequence of phases, and thus such a switching converter is referred to as a multi-phase switching converter. The corresponding inductor-currents from all the (active) power stages together constitute a load-current of the multi-phase switching converter.

There is a general recognized need to operate switching converters with high efficiency, generally measured as a ratio of output power to the input power.

### BRIEF DESCRIPTION OF THE VIEWS OF DRAWINGS

Example embodiments of the present disclosure will be described with reference to the accompanying drawings briefly described below.

FIG. 1 is a block diagram of an example system in which several aspects of the present disclosure can be implemented.

FIG. 2 is a block diagram illustrating the details of a multi-phase switching converter in an embodiment of the present disclosure.

FIG. 3A is a diagram illustrating the implementation of a power stage in an embodiment of the present disclosure.

FIG. 3B is a flowchart illustrating the manner in which a phase controller of a multi-phase switching converter operates to enhance the efficiency of the switching converter in an embodiment of the present disclosure.

FIG. 4 is a block diagram illustrating relevant portions of a phase controller in an embodiment of the present disclosure.

FIG. 5 illustrates an example implementation of a data structure used to determine a frequency of control signals to be provided by a phase controller to respective power stages, in an embodiment of the present disclosure.

FIGS. 6A and 6B illustrate example timing diagrams showing inductor-currents and switching frequencies of control signals, in an embodiment of the present disclosure.

In the drawings, like reference numbers generally indicate identical, functionally similar, and/or structurally similar elements. The drawing in which an element first appears is indicated by the leftmost digit(s) in the corresponding reference number.

### DETAILED DESCRIPTION

### 1. Overview

Aspects of the present disclosure are directed to a multi-phase switching converter that provides a regulated supply voltage from an input voltage.

According to an aspect of the present disclosure, the multi-phase switching converter includes multiple power stages and a phase controller. Each power stage is designed to drive a corresponding inductor to cause flow of a corresponding inductor-current according to a respective phase control signal, with the corresponding inductor-currents from each of the power stages together constituting a load-current of the multi-phase switching converter. The phase controller is designed to determine a frequency of the phase control signals based on magnitudes of the inductor-currents, and to generate the phase control signals with the frequency.

In an embodiment of the present disclosure, each power stage sends information on the corresponding inductor-current to the phase controller, and the phase controller determines the frequency as an optimal frequency at which the power stages operate with optimal power efficiency.

In another embodiment of the present disclosure, the phase controller determines the frequency to be a maximum frequency in a first duration if at least one of a higher phase-count-demand, undershoot and over-current is detected.

Several aspects of the present disclosure are described below with reference to examples for illustration. However, one skilled in the relevant art will recognize that the disclosure can be practiced without one or more of the specific details or with other methods, components, materials and so forth. In other instances, well known structures, materials, or operations are not shown in detail to avoid obscuring the features of the disclosure. Furthermore, the features/aspects described can be practiced in various combinations, though only some of the combinations are described herein for conciseness.

### 2. Example System

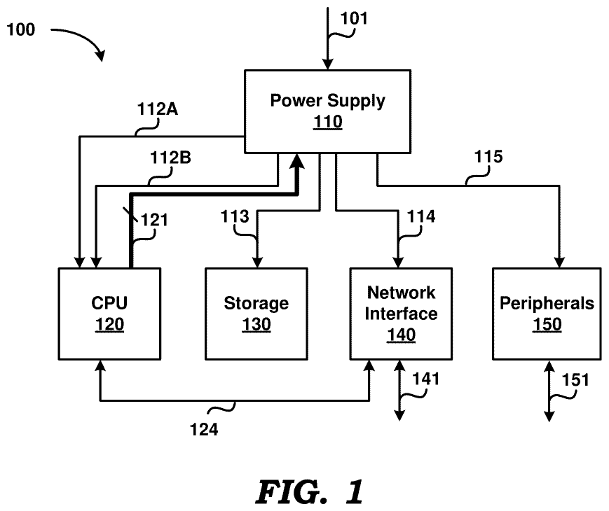

FIG. 1 is a block diagram of an example system in which several aspects of the present disclosure can be implemented. System 100 is shown containing power supply 110, central processing unit (CPU) 120, storage 130, network interface 140 and peripherals 150. In an embodiment, system 100 corresponds to a computer (desktop, laptop, etc.), although system 100 can represent other types of systems in other embodiments. It is understood that system 100 can contain more or fewer blocks than those shown in FIG. 1.

CPU 120, in general, represents a processor or a system-on-chip (SoC), and is shown as receiving a pair of supply voltages (Va and Vb) on respective paths 112A and 112B from power supply 110. As an example, Va may be a smaller voltage than Vb, and may be used to power a core portion of CPU which may include arithmetic logic unit (ALU), microprogram sequencer, registers, etc. Vb may be used to power the rest of CPU 120, such as for example, input/output (I/O) units, I/O buffers, on-chip peripherals etc. CPU 120 provides various signals (all deemed to be contained in path 121) specifying, among others, its power supply requirements to power supply 110. Examples of such signals can be those that specify the specific mode of operation (in terms of power consumption) such as PS1, PS2, PS3, etc., which refer to “Power Save States for Improved Efficiency”.

Storage 130 represents a memory that may include both volatile and non-volatile memories. For example, in a personal computer, storage can include magnetic memory (hard disk) as well as solid state memory (RAM, Flash, etc.). Storage 130 is shown receiving a supply voltage on path 113 for powering various circuits and blocks within.

Network interface 140 operates to provide two-way communication between system 100 and a computer network, or in general Internet. Network controller 140 implements the electronic circuitry required to communicate using a specific physical layer and data link layer standard such as Ethernet or Wi-Fi™. Network interface 140 may also contain a network protocol stack to allow communication with other computers on a same local area network (LAN) and large-scale network communications through routable protocols, such as Internet Protocol (IP). Network interface 140 receives a power supply on path 114 for powering internal circuits and blocks. Network interface 140 communicates with external systems and CPU 120 on path 141 and path 124 respectively.

Peripherals 150 represents one or more peripheral circuits, such as for example, speakers, microphones, user interface devices, etc. Peripherals 150 receives a power supply on path 115, and communicates with external devices on path 151.

Power supply 110 receives one or more sources of power (e.g., battery) on path 101, and operates to provide the desired power supply voltages on paths 112A, 112B, 113, 114 and 115. In an embodiment, power supply 110 is designed to contain one or more DC-DC converters within to generate the power supply voltages. Power supply 110 responds to signals from CPU 120 received on path 121 to reduce/increase current output based on the specific signal (e.g., PS1, PS2 and PS3).

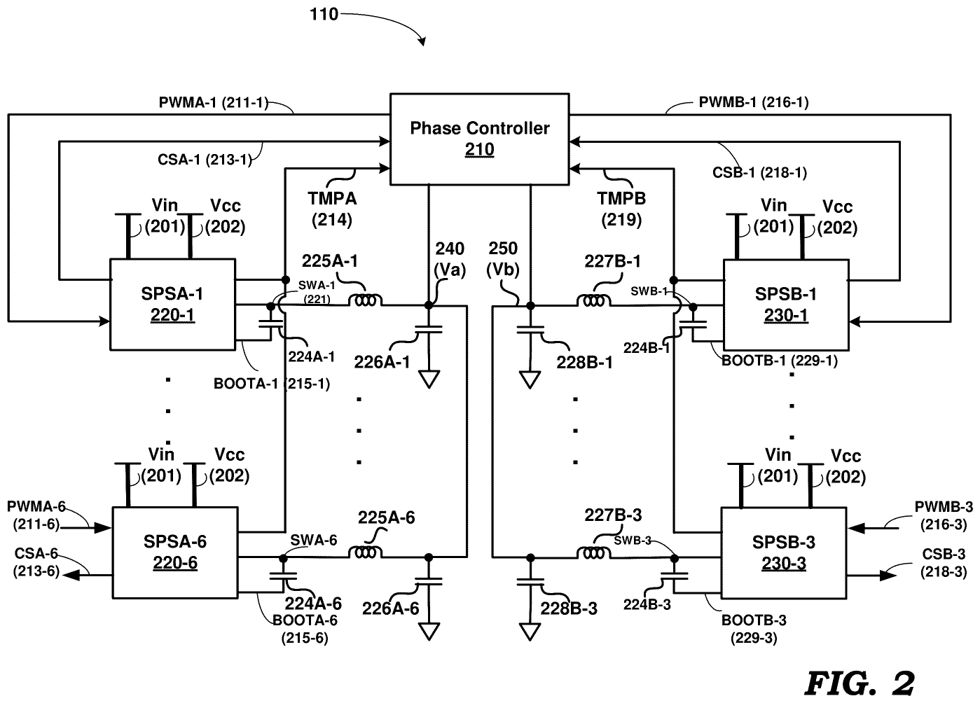

In an embodiment, power supply 110 is a voltage regulator module (VRM), sometimes also called processor power module (PPM), and contains one or more voltage regulators. The voltage regulators include step-down switching (buck) converters to generate several smaller voltages from a higher-voltage supply source. In other embodiments however, other types of DC-DC converters such as boost, buck-boost, hysteretic converters etc., can be implemented instead of a buck converter. With a VRM, multiple devices/ICs requiring different supply voltages can be mounted on the same platform, for example, a computer motherboard of a personal computer (PC). Accordingly, the description is continued with respect to a VRM implemented as a multi-phase switching converter as shown in FIG. 2.

### 3. Multi-Phase Switching Converter

FIG. 2 is a block diagram illustrating the details of power supply 110 (of FIG. 1) in an embodiment of the present disclosure. Power supply 110 is shown implemented as a multi-phase switching converter that generates two regulated power supplies (supply rails) Va (240) and Vb (250), and is shown containing phase controller 210, smart power stages (power stages) (SPS) SPSA-1 (220-1) through SPSA-6 (220-6), SPSB-1 (230-1) through SPSB-3 (230-3), inductors 225A-1 through 225A-6, 227B-1 through 227B-3, output capacitors 226A-1 through 226A-6, 228B-1 through 228B-3, and bootstrap capacitors 224A-1 through 224A-6, 224B-1 through 224B-3.

In the example, power supply Va (240) is generated by a 6-phase buck converter (there are six SPSs-220-1 through 220-6), while power supply Vb (250) is generated by a 3-phase buck converter (there are three SPSs-230-1 through 230-3). Nodes/Paths 240 and 250 correspond to paths 112A and 112B respectively of FIG. 1. In the interest of conciseness, other power supply circuits that generate supplies on paths 113, 114 and 115 are not shown in FIG. 2.

Each bootstrap capacitor associated with an SPS is shown connected between respective nodes SW and BOOT of the corresponding SPS, and provides the high-voltage supply needed to drive the gate terminal of the high-side switch in a power stage when the high-side switch is implemented as an N-channel MOSFET, as is well known in the relevant arts. Thus, bootstrap capacitor 224A-1 is shown connected between switching node SWA-1 (221) and BOOTA-1 (215-1). Although bootstrap capacitor is shown connected external to each SPS, in alternative embodiments, bootstrap capacitor may be internal to the SPS.

Power stages 220-1 through 220-6, and 230-1 through 230-3, may be generically referred below by respective numerals 220 and 230, as will be clear from the context. Also, signals/nodes 211-1 through 211-6, 213-1 through 213-6, 215-1 through 215-6, 216-1 through 216-3, 218-1 through 218-3, 229-1 through 229-3 may be generically referred by respective numerals 211, 213, 215, 216, 218 and 229, as will also be clear from the context. Similar convention is followed for other blocks/components/signals throughout the disclosure.

The combination of (corresponding circuitry within) phase controller 210, a power stage, an inductor and a capacitor forms one “phase” of a multi-phase switching converter. Thus, for example, SPSA-1, inductor 225A-1, capacitor 226A-1, and the corresponding portion within phase controller 210 represent one phase of the 6-phase buck converter.

Each power stage may be implemented to contain a high-side switch, a low-side switch, gate-drive circuitry for the two switches, and other circuits. Examples of other circuits include, but are not limited to, temperature monitor circuit, inductor-current sense (or emulation) circuit, etc., to provide information, such as temperature of the SPS/power stage, magnitude of inductor-current, etc., to phase controller 210. Each SPS receives a source of power as an input which is connected to the high-side switch. In FIG. 2, the supply source is numbered 201, and has a voltage Vin. In an embodiment, the value of Vin is 21 volts (V), and Va and Vb arc respectively 3.3V and 1.8V. Each SPS is also shown receiving a voltage Vcc on path 202. In an embodiment, Vcc has a voltage of 3.3 V, and is provided by phase controller 210.

Each SPS communicates with phase controller 210 via corresponding signals PWM, CS and TMP. Thus, SPSA-1 is shown connected to phase controller 210 through signal/paths PWMA-1 (211), CSA-1 (213) and TMPA (214). SPSA-6 communicates with phase controller 210 via signals PWMA-6, CSA-6 and TMPA (214). Similarly, SPSB-1 is shown connected to phase controller 210 through signal/paths PWMB-1 (216), CSB-1 (218) and TMPB (219). SPSB-3 communicates with phase controller 210 via signals PWMB-3, CSB-3 and TMPB (219). The other SPSs would have similar connections with phase controller 210. In other embodiments, there may be more or fewer numbers of such signals depending on the requirements of the specific operating environments.

Signal TMP is an output from an SPS to phase controller 210, and provides information regarding the temperature in the SPS. Phase controller 210 may process the TMP signal (or the information contained in it) to adjust the current supplied by that phase, or for shut-down of the VRM. The TMP outputs of each phase of a converter are wired together, and a single input is connected to phase controller 210.

Signal CS (current-sense) is an input to phase controller 210 from an SPS, and contains information representing the magnitude of the inductor-current of that phase. The information can be in the form of a current, voltage, digital values, etc.

Signal PWM is an input to an SPS from phase controller 210, and may be viewed as a ‘phase control signal’ that controls the operation (ON and OFF states) of the power switches in the SPS of the corresponding phase.

Phase controller 210 controls the operation of the power stages of the supply rails to cause generation of regulated supply voltages Va and Vb. Phase controller 210 generates PWM signals 211-1 through 211-6 and 216-1 through 216-3 for controlling the power switches of the corresponding rails so as to generate Va and Vb, as is well known in the relevant arts. Typically, the frequencies or duty cycles of the PWM signals are equal.

In an embodiment of the present disclosure, phase controller 210 employs variable frequency, adaptive ON-time control technique to generate Va and Vb. Accordingly, in such an embodiment, signal PWM is a variable frequency, variable pulse-width (adaptive ON-time) signal. Alternatively, or in addition, phase controller 210 may employ variable frequency, constant ON-time control technique to generate Va and Vb based on the specific implementation details of power supply 110. Further still, phase controller 210 may additionally employ fixed-frequency pulse-width modulation mode of operation for some ranges of load-current.

When logic LOW is detected by the SPS on signal PWM, the low-side switch is turned ON, and when logic HIGH is detected on signal PWM, the high-side switch is turned ON. Upon detecting a high-impedance (hi-Z) state (typically mid-rail voltage between power supply and ground) on signal PWM the SPS turns OFF both its high-side and the low-side switches. Thus, an SPS is said to be ‘active’ (‘enabled’) when the corresponding PWM signal is toggling between the HIGH and LOW states, and is said to be ‘inactive’ when the corresponding PWM signal is in hi-Z state. In other words, the SPS is not operational to generate a voltage or supply current when it detects a hi-Z value on PWM signal for a time period greater than a predetermined threshold.

The power stages of a rail are operated to supply current in an interleaved and sequential manner. In other words, the PWM signals to each SPS of multi-phase switching converter 110 are staggered/interleaved, i.e., delayed with respect to each other in phase such that typically the start of the ON durations of the respective high-side switches (and low-side switches) of a rail are not simultaneous. Such a technique is employed for reasons such as, for example, to ensure that the peak instantaneous current drawn from Vin is relatively low, to reduce the ripple in the regulated output voltage, etc.

Phase controller 210 controls the operation of the power stages via the signals noted above to provide various functions including regulating functions to active the generation of regulated voltages Va and Vb by the corresponding sets of power stages. Accordingly, Va and Vb are shown as being provided as inputs to phase controller 210 to active operation of one or more feedback loops within phase controller 210 to regulate Va and Vb.

Phase controller 210 receives inductor-current information (current flowing through each of the inductors) from each of the SPSs to active various operations such as current-mode control of voltage regulation, current limiting, short circuit protection, and balancing the currents generated by each SPS of a same rail (e.g., rail Va) so as to make the currents from each SPS substantially equal in magnitude. Phase controller 210 may additionally perform various other operations which are not noted here in the interest of conciseness.

Phase controller 210 operates to control the power stages (via the corresponding PWM signals) to reduce or increase current output based on the load demand. Phase controller 210 may also receive signals from CPU 120 that indicate a desired power state (e.g., PS1, PS2, etc. noted above) in which the CPU operates from time to time. In response, phase controller 210 may disable/active one or more of power stages 220 depending on the power state and the load-currents.

Broadly, the specific number of phases (power stages) enabled for operation by phase controller 210 can vary depending, for example, on the magnitude of load-current drawn from a rail (e.g., Va 240). In general, the smaller the load-current is, the lesser the number of phases enabled and vice-versa. When a power stage is inactive (i.e., non-operative), both the power switches of the power stage are always OFF, and the power stage does not contribute any current (inductor-current) in generating the regulated voltage (e.g., Va).

Phase controller 210 operates to detect undershoots in regulated supply voltages (Va or Vb). An undershoot refers to a transient change in a regulated supply voltage, in which the regulated supply voltage falls below a permissible lower limit (for example, falls by at least 5% of the nominal regulated supply voltage). Such undershoots may be, for example, due to sudden spikes/increases in load-current (current drawn by one or more loads from the regulated supply node (Va/Vb)).

Phase controller 210 also operates to detect over-current conditions in the inductor-currents (for example, based on the CS signals received from the active SPSs). An over-current condition refers to a condition in which the inductor-current of a power stage exceeds a threshold limit (referred to as over-current limit). In addition or alternatively, each power stage is designed to detect an over-current condition in (with respect to) the inductor-current generated by it (the power stage), and indicate such over-current condition to phase controller 210.

It is generally desirable that the efficiency of power supply 110 be as high as possible. Efficiency refers to the ratio of output power delivered by the power supply to the input power drawn by the power supply from the supply source Vin. It is noted here that some power for operation is drawn from Vcc and the source powering phase controller 210. However, the power drawn from these sources are negligible compared to that drawn from Vin, and therefore may be disregarded. Thus, typically the most significant components of power losses in power supply 110 are the power losses in (or due to) the power switches in each operating power stage. Accordingly, details of a power stage in an embodiment of the present disclosure are provided next and briefly described.

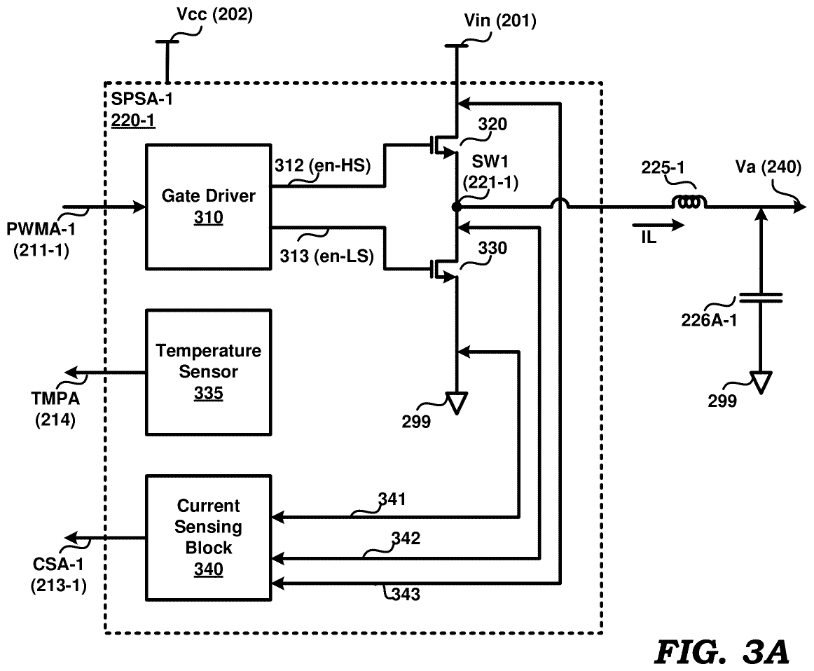

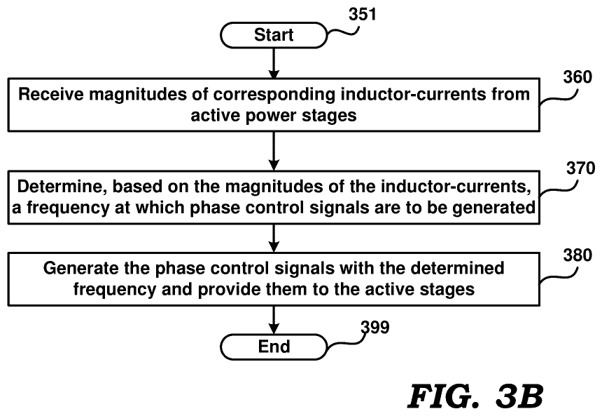

FIG. 3A is a diagram illustrating the implementation of a power stage in an embodiment of the present disclosure. SPSA-1 (220-1) is shown in FIG. 3A. The other power stages can also be implemented to be similar to SPSA-1. The bootstrap capacitor and the associated connections and circuitry are not shown in FIG. 3A in the interest of conciseness. SPSA-1 is shown containing gate driver 310, high-side (HS) switch 320, low-side (LS) switch 330, temperature sensor 335 and current sensing block 340. HS switch 320 and LS switch 330 represent the power switches (noted above) of the power stage. Also shown in FIG. 3A are inductor 225-1 and capacitor 226A-1. Node 240 provides the regulated supply voltage Vout (Va). It is noted that the specific implementation details of SPSA-1 are provided merely by way of illustration. In other embodiments, an SPS can have more or fewer blocks.

Temperature sensor 335 measures the ambient temperature at SPS 220A-1 periodically, and provides the temperature values on path 214. Phase controller 210 may receive the temperature values from time to time and take appropriate action in the event the temperature values exceed acceptable levels.

Gate driver 310 receives control signal PWMA-1, and in response to the logic level of PWMA-1 generates the appropriate voltages on respective paths 312 (en-HS) and 313 (en-LS) to turn ON and turn OFF HS switch 320 and LS switch 330 in corresponding intervals indicated by PWMA-1. HS switch 320 and LS switch 330 are each shown implemented as an NMOS (N-channel Metal Oxide Semiconductor Field Effect Transistor-MOSFET) with gate driver 310 driving the gate terminals of the NMOSs, although other implementations for the switches are possible.

In the example of FIG. 3A, when PWMA-1 is a logic high (corresponding to the first interval of each PWM cycle), gate driver 310 generates respective appropriate voltages on paths 312 (en-HS) and 313 (en-LS) to switch ON MOSFET 320 and switch OFF MOSFET 330. When PWMA-1 is a logic low (corresponding to the second interval of each PWM cycle), gate driver 310 generates respective appropriate voltages on paths 312 and 313 to switch OFF MOSFET 320 and switch ON MOSFET 330.

Current sensing block 340 operates to sense the inductor-current (IL) and thereby construct a (scaled/non-scaled) copy of the inductor-current in each of the first intervals (HS interval) and second intervals (LS intervals). In FIG. 3A, current sensing block 340 is shown as receiving the respective voltage drops across switches 320 (based on paths 342 and 343) and 330 (based on paths 341 and 342) to generate the copy. Current sensing block 340 provides the scaled/non-scaled copy to phase controller 210 on path CSA-1.

Phase controller 210 may make use of the copy of the inductor-currents reported by active power stages in operating one or more regulation feedback loop(s) operative in phase controller 210 to provide a regulated voltage of a desired magnitude Vout as output 240, as well as for other purposes, such as, for example, detection of spikes in load-current.

In general, loss components such as switching loss (losses due to switching ON/OFF of power switches), conduction loss (voltage drop across the switches), dead-time loss (short between Vin and ground due to both power switches of a power stage being simultaneously ON), etc., represent the main loss components that impact the overall efficiency of a switching converter. Out of these, some of the components such as switching loss depend on the switching frequency, while other components such as conduction loss depend on the operating current level, ripple, etc.

Several aspects of the present disclosure are directed to enhancing the efficiency of a multi-phase switching converter, as described in detail below.

### 4. Flow-Chart

FIG. 3B is a flowchart illustrating the manner in which a phase controller of a multi-phase switching converter operates to enhance the efficiency of the switching converter, according to an aspect of the present disclosure. The flow-chart is described with respect to the system/multi-phase switching converter of FIGS. 1 and 2 merely for illustration. However, many of the features can be implemented in other systems and/or other environments also without departing from the scope and spirit of several aspects of the present disclosure, as will be apparent to one skilled in the relevant arts by reading the disclosure provided herein.

In addition, some of the steps may be performed in a different sequence than that depicted below, as suited to the specific environment, as will be apparent to one skilled in the relevant arts. Many of such implementations are contemplated to be covered by several aspects of the present disclosure. The flow-chart begins in step 351, in which control immediately passes to step 360.

In step 360, phase controller 210 receives magnitudes of corresponding inductor-currents from active (i.e., enabled) power stages (SPSs). In an embodiment, phase controller 210 receives the magnitudes of the corresponding inductor-currents from the current-sense (CS) output terminals of the power stages in the form of a scaled replica of the inductor-current. However, in other embodiments, phase controller 210 may receive the inductor-current magnitude in other forms, such as for example a voltage, a digital value/number, etc. Control passes to step 370.

In step 370, phase controller 210 determines, based on the magnitudes of the inductor-currents, a frequency at which the phase control signals (PWM signals) are to be generated. As is well known in the relevant arts, the inductor-current of a power stage increases linearly when the HS switch of the stage is ON and then decreases linearly when the LS switch of the stage is ON in each cycle of the PWM signal. Therefore, phase controller 210 computes the average value of the inductor-current in a PWM cycle based on the received replica from the CS output(s) noted above, and determines the frequency of the PWM signals based on the average value. As noted above, the inductor-currents of all the active power stages are equal. Therefore, phase controller 210 needs to process the inductor-current information received from any one active power stage only. Alternatively, phase controller 210 can determine the frequency based on the maximum (peak) value of the inductor-current, minimum (valley) value of the inductor-current, etc., in combination with the cycle duration (period) of the present PWM clock. The frequency is selected to optimize the power efficiency of switching converter 110.

In general, lower the switching frequency, lower are the switching losses in the power switches. However, as switching frequency reduces, other factors that contribute to power losses can become increasingly significant. For example, the ripple in inductor-current increases with reducing switching frequencies, which in turn increases conduction losses, and the increasing ripple can also potentially lead to inductor-current saturation. Therefore, for a particular single (average/peak/valley, etc.) value of inductor-current, or for given range of (average/peak/valley, etc.) values of the inductor-current, there exists an optimal switching frequency that provides the maximum efficiency. Phase controller 210 determines the value of such optimal switching frequency based on the present/received magnitude of the inductor-current(s). In addition to the consideration of maximizing efficiency, or alternatively, phase controller 210 determines the switching frequency as that frequency which also provides a sufficient margin from inductor-current saturation. In other words, phase controller 210 selects that value of switching frequency which is also high-enough (for the corresponding inductor-current magnitude or range of magnitudes) such that for a predetermined jump (increase) in load-current, any corresponding increase (if it were allowed) in inductor-current does not cause the inductor to saturate. Irrespective of the consideration(s) taken into account by phase controller 210 for determining the value of the switching frequency, it is deemed herein that the determined value of the switching frequency is “optimal” or, in other words, the determined switching frequency causes the active power stages (and therefore the entire switching converter) to operate with “optimal power efficiency”.

Control then passes to step 380.

In step 380, phase controller 210 generates the PWM signals with the determined frequency, and provides the PWM signals to the active power stages. Control then passes to step 399, in which the flowchart ends.

Using the inductor-current magnitudes to determine the required PWM switching frequency may be advantageous over using the load-current magnitude for such purpose. This is because the load-current magnitude alone cannot indicate which ones (and how many) of the power stages are presently active, which may require additional time, and therefore delay changing the PWM switching frequency if necessary. Further, at least in some scenarios, the accuracy and/or resolution with which the magnitude of the load-current can be measured can be poorer than that with which the magnitude of inductor-current can be measured, since the inductor-current range is usually much smaller than the load-current range.

Phase controller 210 repeats the process of FIG. 3B to continuously monitor and adjust the switching frequency for example, as long as at least one SPS is active.

Partial implementation details of phase controller 210 for generating the PWM signals with optimal frequencies in an embodiment of the present disclosure are provided next.

### 5. Phase Controller

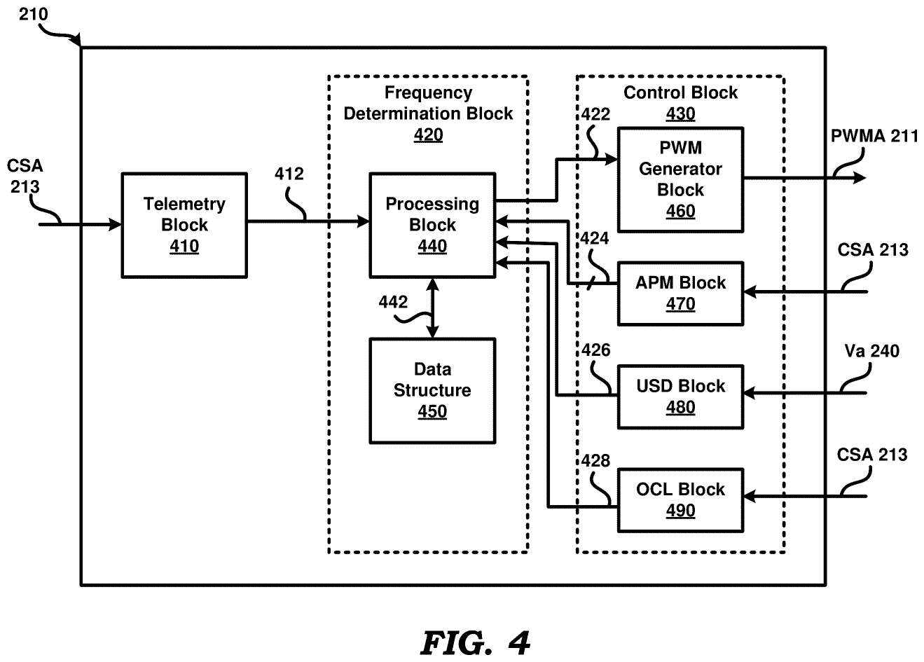

FIG. 4 is a block diagram illustrating relevant portions of a phase controller in an embodiment of the present disclosure. Phase controller 210 is shown as containing telemetry block 410, frequency determination block 420, and control block 430. Frequency determination block 420 is shown further containing processing block 440 and data structure 450, and control block 430 is shown further containing PWM generator block 460, automatic phase management (APM) block 470, undershoot detection (USD) block 480 and over current limit (OCL) block 490. The portions/blocks shown in FIG. 4 are described as being for controlling the power stages of rail A (Va). It is noted here that only those blocks as relevant to the understanding of the disclosure herein are depicted in FIG. 4. It is understood that phase controller 210 can contain more or fewer blocks than those shown in FIG. 4. For example, some of the blocks in FIG. 4 may be replicated (with appropriate inputs) to provide corresponding functionality for rail Vb (250). The internal blocks of phase controller 210 may be powered by a source, not shown. The blocks of FIG. 4 may be implemented in a known way.

Telemetry block 410 receives CS signals (213), which contain information representing magnitudes of the corresponding (but typically equal average values) inductor-currents from the corresponding active SPSs, and converts the analog signals to digital values. In an embodiment, CS signal 213 received from an SPS is a scaled-down replica of the corresponding inductor-current. Telemetry block 410 computes the average of the digital values of any one of the replica currents over a PWM cycle period. Alternatively, telemetry block 410 may store the peak or valley values of the replica in a PWM cycle. In the description below, it is assumed that telemetry block 410 computes the average value of the replica current, and hence will not refer to other peak, valley or other characteristics that may be employed instead also. Telemetry block 410 multiplies the average value by the inverse of the scaling-down factor employed in the power stage, and forwards the resulting (actual) value of the (average) inductor-current to processing block 440.

It is noted here that, the CS signals from all power stages of rail-A (Va) are received at telemetry block 410, which also receives from APM block 470 (via processing block 440) information indicating which of the power stages are currently active/enabled. Therefore, telemetry block 410 may process, as noted above, only one of those CS signals that correspond to the currently active power stages, since all the inductor-currents are equal, i.e., have substantially the same average values, and forward the appropriately scaled value of the average to processing block 440 on path 412. Alternatively, when small variations exist between the average values of individual inductor-currents of the active power stages, telemetry block 410 may forward scaled values of such different average values to processing block 440 on path 412 (processing block 440 then computing an average of the received average values), or telemetry block 410 may further compute an average of the average values of the individual inductor-currents, and forward the appropriately scaled value of the average to processing block 440 on path 412.

APM block 470 determines magnitude of the load-current presently drawn from rail Va, and if the magnitude is greater/lesser than that in the previous PWM cycle (or immediately prior to a predetermined interval), generates signals on path 424 indicating if more/fewer power stages need to be made active. In an example implementation, APM block 470 determines the magnitude of the load-current based on CS signals 213. APM block 470 adds the individual inductor-currents reported in the CS signals to obtain the load-current magnitude. In an alternative embodiment, APM block 470 contains circuitry to directly measure the load-current drawn from Va. Depending on the change in load-current, APM block 470 determines how many, as well as which of the, power stages should be enabled/active, and forwards such information to processing block 440. In addition, APM block 470 would forward such information to PWM generator block 460 (though the path is not indicated in FIG. 4) to enable generation of PWM signals for the active power stages. Any update, indicating that more power stages than presently active need to be operational/active, from APM block 470 on path 424 can potentially be an indication that the load-current has increased.

In an example implementation, APM block 470 generates a signal which is n-bits wide, ‘n’ being the total number of phases (i.e., power stages) in multi-phase switching converter 110, wherein each bit indicates whether the corresponding one of the phases is to be active or not. As an example, for moderate load-currents drawn from rail Va (240), APM block 470 may generate a signal ‘111000’ on path 424 indicating that SPSA-1 (220-1) through SPSA-3 (220-3) need to be in active mode and SPSA-4 (220-4) through SPSA-6 (220-6) need to be in inactive mode; and for high load-currents, APM block 470 may generate a signal ‘111111’ indicating that all six power stages (SPSA-1 (220-1) through SPSA-6 (220-6)) need to be in active mode. It may be appreciated that the n-bit signal may be sent whenever the number of active power stages needs to change (based on a corresponding change in load-current).

USD block 480 continually senses/measures the voltage on output node Va (240). If voltage Va falls below a predetermined threshold (e.g., 5%) below the desired regulated value of voltage Va, USD block 480 generates a logic signal on path 426 to indicate ‘undershoot’. USD block 480 can be implemented, for example, using comparators (with hysteresis) and reference voltage(s). An undershoot indication on path 426 is an indication that the load-current has increased substantially.

OCL block 490 receives current-sense signals CS 213 from the power stages. OCL block 490 contains one or more comparators to determine whether the instantaneous per-phase current (i.e., sensed-inductor-current/scaled-replica from a power stage) has exceeded an over-current limit. OCL block 490 may similarly compare the other per-phase currents with the same over-current limit. In an embodiment, the over-current limit represents a value which is slightly lower than the (smaller of) the maximum instantaneous per-phase current that a power stage can handle and the saturation current of the corresponding inductor.

Upon detecting that the instantaneous inductor-current of at least one power stage has exceeded the overcurrent-limit, OCL block 490 indicates that an over-current limit has been exceeded on path 428 using a logic signal. Such an indication also indicates that the load-current has increased.

Data structure 450 maps different ranges of magnitudes of inductor-current to the corresponding optimal frequencies. The ranges are chosen so as to improve the overall efficiency of the switching converter. In an embodiment, data structure 450 is implemented in a re-writable memory, and the data (containing mappings between magnitudes of the inductor-current and the corresponding optimal frequencies) in data structure 450 can be updated/changed. Data structure 450 may be implemented using techniques known in the relevant arts.

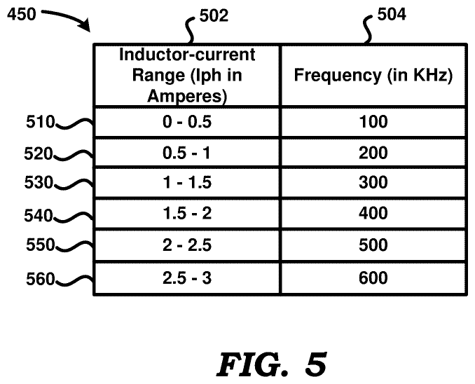

In an embodiment, data structure 450 is implemented as a look-up table (LUT), an example of which is illustrated in FIG. 5. As illustrated in FIG. 5, column 502 (“Inductor-current Range (in Amperes)”) specifies ranges of inductor-current magnitudes (magnitudes represent average value in a PWM cycle), and column 504 (“PWM Frequency (in KHz)”) specifies optimal frequencies for the corresponding ranges of inductor-currents. Thus, row 510 specifies inductor-current range of “0-0.5 A” (column 502) and the corresponding optimal PWM switching frequency of “100 KHz” (column 504). Similarly, the other rows of LUT 450 specify the corresponding optimal frequencies for other ranges of the inductor-current. It is assumed in the example illustration of FIG. 5 that 3 A is the expected maximum inductor-current. It may be understood that the values in LUT 450 are merely for illustration, and that the values may be chosen taking various factors into consideration.

Processing block 440 operates to select a PWM switching frequency from LUT 450 (accessed via path 442), and forwards the selected frequency on path 422 to PWM generator block 460, which in turn generates the PWM signal(s) at the received frequency. PWM generator block 460 is further described below. In an embodiment of the present disclosure, processing block 440 evaluates whether or not a new PWM frequency (to be applied from the end of the present PWM cycle) must be determined (based on the entries in LUT 450), at intervals of one cycle of the PWM signal at the present PWM switching frequency. In other embodiments, the evaluation may be made at less frequent intervals. However, if any of the signals/data received on paths 424, 426 and 428 are indicative of an increase in load-current, then processing block 440 selects the highest value of PWM switching frequency in LUT 450 as the new PWM frequency (to be applied from the end of the present PWM cycle), and forwards the highest value to PWM generator block 460. The selection of the highest PWM switching frequency is to prevent the possibility of saturating one or more of the inductors of the power stages. As is well known in the relevant arts, lower the PWM switching frequency is, larger is the inductor-current ripple. Therefore, if the inductor-current were to be increased without also increasing the PWM switching frequency, there is the possibility of inductor saturation, which is not desirable since saturation would cause the inductance of the inductor to reduce, and therefore negatively affect the operation of the switching converter.

Processing block 440 receives the average inductor-current magnitude from telemetry block 410 on path 412. As an example, depending on the speed/design of telemetry block 410, processing block 440 may receive the average inductor-current magnitude either at the end of each PWM cycle, or at less frequent intervals. Processing block 440 also receives the data and signals sent on paths 424, 426 and 428 from APM block 470, USD block 480 and OCL block 490 respectively as/when they are sent (typically only when there is a change from a previous or normal condition). Based on the received inputs on paths 412, 424, 426 and 428, processing block 440 retrieves the appropriate PWM switching frequency from LUT 450.

If none of the data/signals received on paths 424, 426 and 428 is indicative of an increase in the load-current, then processing block 440 retrieves from LUT 450 the PWM switching frequency value corresponding to the presently received magnitude of inductor-current from telemetry block 410, and forwards the retrieved PWM switching frequency value to PWM generator block 460.

However, if at least one of the data/signals received on paths 424, 426 and 428 is indicative of an increase in load-current, then processing block 440 selects the highest value of PWM switching frequency in LUT 450, and forwards the highest value to PWM generator block 460, as also noted above. Additionally, one or more inactive power stages may be made active to enable the switching converter to meet the increased load-current demand. Although not shown in FIG. 4, processing block 440, upon receipt of assertion of one or more of signals 424, 426 and 428, would send a signal to a stage activation block (not shown). The stage activation block obtains the number and identification of the presently active power stages from APM block 470, and activate the required number of inactive power stages in response to the communication from processing block 440.

It may be appreciated that the data/signals received on paths 424, 426 and 428 are merely indicative of an increase in load-current, but may not indicate the quantum of increase. Nonetheless, processing block 440 operates to retrieve the highest PWM switching frequency and PWM generator block 460 sets the PWMA (211) signals with the retrieved switching frequency so as to preempt any possibility of inductor current saturation.

Thus, phase controller 210 generates the PWM signals with optimal frequencies to enable maximum power efficiency while also preventing inductor current saturation.

Examples of selection of the PWM switching frequency are provided next with respect to examples.

### In Case of No ‘Higher Phase Count Demand’ AND No ‘Undershoot Detection’ AND No ‘Over Current Limit Exceeded’

If the data on path 424 does not indicate a ‘higher phase count demand’ (i.e., additional power stages do not need to be enabled), and if the signal on path 426 does not indicate an ‘undershoot’ condition and if the signal on path 428 does not indicate that an over-current limit has been exceeded, processing block 440 determines the PWM switching frequency based only on the magnitude of inductor-current presently received on path 412.

As an example, if SPSA-1, SPSA-2 and SPSA-3 are the active SPSs, and processing block 440 receives 0.69 A, 0.7 A and 0.71 A as the corresponding average inductor-currents of the 3 active power stages on path 412, processing block 440 determines that all the digital values are in the same range (i.e., 0.5-1 A in LUT 450) by examining LUT 450, and retrieves the corresponding frequency entry in the LUT (i.e., 200 KHz) via path 442.

However, if the average inductor-currents happen to fall in different ranges (e.g., one in range 0-0.5 A, and the other two in 0.5 to 1 A), processing block 440 may compute an average of the three currents, and retrieve the frequency corresponding to the range in which the average value falls. As an example, if SPSA-1, SPSA-2 and SPSA-3 are the active SPSs, and processing block 440 receives 0.49 A, 0.51 A and 0.53 A as the corresponding inductor-currents, processing block 440 determines that the currents fall in different ranges in LUT 450. Therefore, processing block 440 computes the average (which is 0.51 A), and accordingly retrieves the value 200 KHz.

Alternatively, if the inductor-currents fall in difference ranges, processing block 440 may be designed to output the PWM frequency corresponding to the highest or lowest values of the inductor-current.

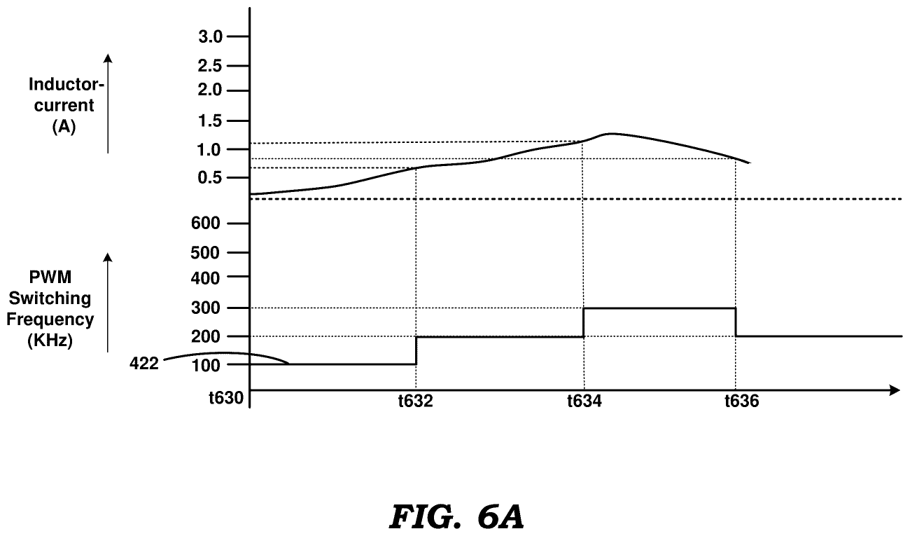

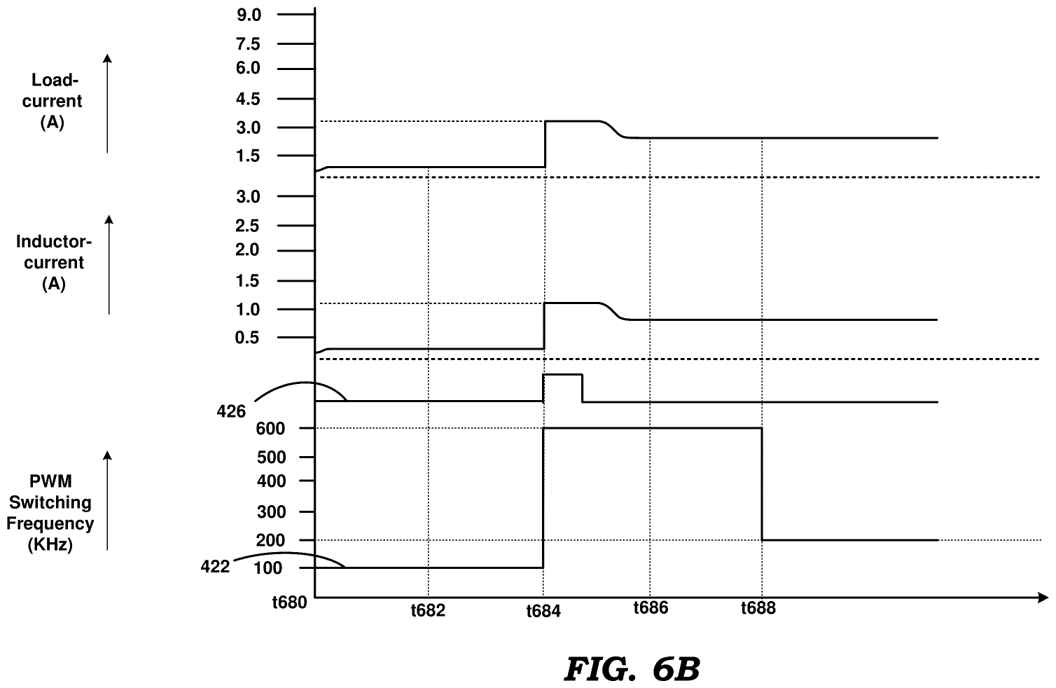

FIG. 6A illustrates an example diagram illustrating the correspondence between (average) inductor-current (IL) and the selected PWM switching frequency. In the illustration of FIG. 6A, it is assumed that only SPSA-1, SPSA-2 and SPSA-3 are active, and the inductor-currents of all the active power stages are the same.

As illustrated in FIG. 6A, at time 1630, processing block 440 receives 0.15 A, 0.15 A and 0.15 A as the values of inductor-currents corresponding to SPSA-1, SPSA-2 and SPSA-3. Processing block 440 examines LUT 450 and determines that the received values are all in the same range of 0-0.5 A (row 510 in LUT 450 of FIG. 5). Hence, processing block 440 outputs 100 KHz as the PWM frequency value on path 422.

Similarly, at times 1632, 1634 and t636 respectively, processing block 440 outputs 200 KHz (inductor-current is 0.7 A, and falling in the range 0.5 to 1.0 A), 300 KHz (inductor-current is 1.1 A, and falling in the range of 1.0-1.5 A), and 200 KHz (inductor-current is 0.85 A, and falling in the range of 0.5 to 1.0 A).

### In Case of ‘Higher Phase Count Demand’ OR ‘Undershoot Detection’ OR ‘Over Current Limit Exceeded’

If the data on path 424 indicates a ‘higher phase count demand’ (i.e., additional power stages need to be enabled) or if the signal on path 426 indicates an ‘undershoot’ condition or if the signal on path 428 indicates that an over-current limit has been exceeded, then processing block 440 ignores the signals on path 412 and selects the highest value of PWM switching frequency in LUT 450, and forwards the highest value (600 KHz in the example of FIG. 5) to PWM generator block 460 on path 422, to prevent the inductors from entering the saturation state. However, in alternative embodiments, processing block 440 may output a different higher frequency (instead of the highest frequency of 600 KHz) based, for example, on an estimate of the change in load-current.

After sending the highest frequency value to PWM generator block 460, processing block 440 monitors the inductor-current magnitudes received on path 412. If the inductor-current magnitudes fall below a pre-defined threshold and stay below this threshold for a certain duration (referred to as debounce time), processing block 440 reduces the switching frequency to a corresponding lower value based on LUT 450.

FIG. 6B illustrates an example diagram illustrating the correspondence among load-current, inductor-current (IL), a signal on path 426 indicating an ‘undershoot’ condition, and the selected PWM switching frequency. In the illustration of FIG. 6B, it is assumed that only SPSA-1, SPSA-2 and SPSA-3 are active, and the inductor-currents of all the active power stages are the same.

As illustrated in FIG. 6B, at time t680, the load-current is 0.6 A and the inductor-current in each of SPSA-1, SPSA-2 and SPSA-3 is 0.2 A. Processing block 440 receives 0.2 A, 0.2 A and 0.2 A as the values of inductor-currents corresponding to SPSA-1, SPSA-2 and SPSA-3. Processing block 440 examines LUT 450 and determines that the received values are all in the same range of 0-0.5 A (row 510 in LUT 450 of FIG. 5). Hence, processing block 440 outputs 100 KHz as the PWM frequency value on path 422.

At time t682, processing block 440 outputs 100 KHz (inductor-current is 0.3 A, and falling in the range 0 to 0.5 A).

However, at time t684, there is a sudden increase in the load-current, resulting in an ‘undershoot’ in voltage Va. USD block 480 detects the ‘undershoot’ condition and sends a logic HIGH signal on path 426 indicating the ‘undershoot’ condition. Processing block 440 detects the logic HIGH signal on path 426, ignores the inputs on path 412, and selects 600 KHz (the highest frequency in LUT 450) and forwards the same to PWM generator block 460 on path 422.

At time t686, processing block 440 receives 0.8 A (inductor-current falling in a lower range) as the value of the inductor-current on path 412. However, processing block 440 does not immediately output the optimal frequency corresponding to 0.8 A. At time t688, processing block 440 again receives 0.8 A as the value of the inductor-current and determines that the debounce time has elapsed and the inductor-current is still in the lower range, and outputs 200 KHz (the frequency corresponding to 0.8 A) as the optimal frequency.

Thus, processing block 440 prevents the inductors from entering saturation state, by forwarding the highest frequency in LUT 450 as the optimal frequency, when an ‘undershoot’ condition is detected.

Similarly, processing block 440 prevents the inductors from entering saturation state, by forwarding the highest frequency in LUT 450 as the optimal frequency, in case of higher phase count demand or over current detection.

Processing block 440 may be implemented using techniques known in the relevant arts, as would be apparent to a skilled practitioner from the present disclosure.

PWM generator block 460 receives the optimal PWM switching frequency from processing block 440 on path 422. PWM generator block 460 determines the ON-time (T-ON, i.e., logic HIGH pulse duration) to be set for the PWM signals provided on paths PWMA-211 based on the received optimal PWM switching frequency and the required duty-cycle of the PWM signals. The required duty-cycle (D) equals the ratio Vout/Vin, wherein Vout is the regulated output voltage (here, Va 240), and Vin is the voltage of the input power source (Vin 201 shown in FIGS. 2 and 3A). PWM generator block 460 may be implemented in a known way.

The techniques of the present disclosure may be particularly advantageous when the switching converter is operating in continuous conduction mode (CCM), in which the load-currents are usually high and it is desirable to improve the efficiency of the switching converter while also preventing the inductors from entering saturation state.

It is noted here that, in an embodiment of the present disclosure, the entries of LUT 450 are determined a priori based on measurements made in a laboratory setting by subjecting switching converter 110, and in particular the power stages (e.g., 220-1, etc.), to varying load currents (e.g., with a variable test load connected to node 240 (Va)), and making various relevant measurements (and/or using formulas) such as switching loss, conduction loss, margin available for inductor-current saturation, etc., for various PWM switching frequencies. The entries thus determined are then stored in a non-volatile memory in phase controller 210, and used during normal operation.

It may also be appreciated that the techniques of the present disclosure enable setting the PWM switching frequency to that value (among a range of nearby or contiguous values) which results in maximum power efficiency for the switching converter at least when the load current is constant (a fixed single value), or is otherwise varying only slowly. A sudden and substantial change in the load current would normally be reflected in one or more of the outputs of APM block 470, USD block 480 and OCL block 490. By reacting to any such indication from the blocks to apply the highest switching frequency the techniques ensure that inductor-current saturation never occurs. The highest switching frequency (e.g., 600 KHz) of LUT 450 would have been tested and confirmed during the test measurements noted above as not causing inductor current saturation for the maximum expected load-current for which the switching converter is designed.

### 6. Conclusion

References throughout this specification to “one embodiment”, “an embodiment”, or similar language means that a particular feature, structure, or characteristic described in connection with the embodiment is included in at least one embodiment of the present disclosure. Thus, appearances of the phrases “in one embodiment”, “in an embodiment” and similar language throughout this specification may, but do not necessarily, all refer to the same embodiment.

While in the illustrations of FIGS. 1, 2, 3A and 4, although terminals/nodes are shown with direct connections to (i.e., “connected to”) various other terminals, it should be appreciated that additional components (as suited for the specific environment) may also be present in the path, and accordingly the connections may be viewed as being “electrically coupled” to the same connected terminals.

In the instant application, the power and ground terminals are referred to as constant reference potentials.

While various embodiments of the present disclosure have been described above, it should be understood that they have been presented by way of example only, and not limitation. Thus, the breadth and scope of the present disclosure should not be limited by any of the above-described embodiments, but should be defined only in accordance with the following claims and their equivalents.

What is claimed is:

1. A multi-phase switching converter to provide a regulated supply voltage from an input voltage, said multi-phase switching converter comprising:
a plurality of power stages, each power stage to drive a corresponding inductor to cause flow of a corresponding inductor-current according to a respective phase control signal, wherein said corresponding inductor-currents from each of said plurality of power stages together constitute a load-current of said multi-phase switching converter; and
a phase controller to determine a frequency of said phase control signals based on magnitudes of said inductor-currents, and to generate said phase control signals with said frequency.

2. The multi-phase switching converter of claim 1, wherein each power stage of said plurality of power stages sends information on the corresponding inductor-current to said phase controller,
wherein said phase controller determines said frequency as an optimal frequency at which said plurality of power stages operate with optimal power efficiency.

3. The multi-phase switching converter of claim 2, wherein said phase controller determines said frequency to be a maximum frequency in a first duration if at least one of a higher phase-count-demand, undershoot and over-current is detected,
wherein said higher phase count demand refers to a condition wherein a load-current drawn from a rail in a period requires a higher number of power stages to be in active mode than in an immediately preceding period,
wherein said undershoot is a decrease in magnitude of said regulated supply voltage wherein said magnitude of said regulated supply voltage falls below an allowed lower limit for said regulated supply voltage, and
wherein said over-current is a condition wherein inductor-current corresponding to a power stage is in excess of a maximum limit.

4. The multi-phase switching converter of claim 3, wherein said phase controller generates said phase control signals with said frequency and a duty-cycle determined by at least the magnitude of said regulated supply voltage and the magnitude of said input voltage.

5. The multi-phase switching converter of claim 3, wherein each of said plurality of power stages generates a current-sense signal representing a magnitude of said corresponding inductor current, wherein said phase controller comprises:
a telemetry block to receive said current-sense signals and generate digital values representing said magnitudes;
a frequency determination block coupled to receive said digital values and to output said frequency; and
a control block coupled to receive said frequency, and to generate said phase control signals with said frequency and said duty-cycle.

6. The multi-phase switching converter of claim 5, wherein said frequency determination block comprises a look-up table (LUT) which maps different combinations of magnitudes of said inductor-currents to corresponding optimal frequencies, wherein said frequency is determined by examining said LUT.

7. A method of generating phase control signals in phase controller of a multi-phase switching converter, said method comprising:
receiving magnitudes of corresponding inductor-currents from a plurality of power stages of said multi-phase switching converter, wherein said corresponding inductor-currents from each of said plurality of power stages together constitute a load-current of said multi-phase switching converter;
determining, based on said magnitudes of said corresponding inductor-currents, a frequency at which said phase control signals are to be generated; and
generating said phase control signals with said determined frequency and providing said phase control signals to said plurality of power stages.

8. The method of claim 7, wherein each power stage of said plurality of power stages sends information on the corresponding inductor-current to said phase controller,
wherein said phase controller determines said frequency as an optimal frequency at which said plurality of power stages operate with optimal power efficiency.

9. The method of claim 8, wherein said frequency is determined to be a maximum frequency in a first duration if at least one of a higher phase-count-demand, undershoot and over-current is detected,
wherein said higher phase count demand refers to a condition wherein a load-current drawn
from a rail of said multi-phase switching converter in a period requires a higher number of power stages to be in active mode than in an immediately preceding period,
wherein said undershoot is a decrease in magnitude of a regulated supply voltage provided by a multi-phase switching converter, wherein said magnitude of said regulated supply voltage falls below an allowed lower limit for said regulated supply voltage, and
wherein said over-current is a condition wherein inductor-current corresponding to a power stage is in excess of a maximum limit.

10. The method of claim 9, further comprising generating said phase control signals with said frequency and a duty-cycle determined by at least the magnitude of said regulated supply voltage and the magnitude of said input voltage.

11. The method of claim 9, further comprising:
receiving current-sense signals from each of said plurality of power stages, wherein a current-sense signal representing a magnitude of said corresponding inductor current, and generating digital values representing said magnitudes;
receiving said digital values and determining said frequency; and
generating said phase control signals with said determined frequency and said duty-cycle.

12. The method of claim 11, wherein said frequency is determined by examining a look-up table (LUT) which maps different combinations of magnitudes of said inductor-currents to corresponding optimal frequencies.

13. A phase controller for generating phase control signals in a multi-phase switching converter, said phase controller to:
receive magnitudes of corresponding inductor-currents from a plurality of power stages of said multi-phase switching converter, wherein said corresponding inductor-currents from each of said plurality of power stages together constitute a load-current of said multi-phase switching converter;
determine, based on said magnitudes of said corresponding inductor-currents, a frequency at which said phase control signals are to be generated; and
generate said phase control signals with said determined frequency and provide said phase control signals to said plurality of power stages.

14. The phase controller of claim 13, wherein each power stage of said plurality of power stages sends information on the corresponding inductor-current to said phase controller,
wherein said frequency is determined as an optimal frequency at which said plurality of power stages operate with optimal power efficiency.

15. The phase controller of claim 14, wherein said phase controller to determine said frequency to be a maximum frequency in a first duration if at least one of a higher phase-count-demand, undershoot and over-current is detected,
wherein said higher phase count demand refers to a condition wherein a load-current drawn
from a rail of said multi-phase switching converter in a period requires a higher number of power stages to be in active mode than in an immediately preceding period,
wherein said undershoot is a decrease in magnitude of a regulated supply voltage provided by a multi-phase switching converter, wherein said magnitude of said regulated supply voltage falls below an allowed lower limit for said regulated supply voltage, and
wherein said over-current is a condition wherein inductor-current corresponding to a power stage is in excess of a maximum limit.

16. The phase controller of claim 15, wherein said phase controller to generate said phase control signals with said frequency and a duty-cycle determined by at least the magnitude of said regulated supply voltage and the magnitude of said input voltage.

17. The phase controller of claim 15, said phase controller comprising:
a telemetry block to receive said current-sense signals and generate digital values representing said magnitudes;
a frequency determination block coupled to receive said digital values and to output said frequency; and
a control block coupled to receive said frequency, and to generate said phase control signals with said frequency and said duty-cycle.

18. The phase controller of claim 17, wherein said frequency determination block comprises a look-up table (LUT) which maps different combinations of magnitudes of said inductor-currents to corresponding optimal frequencies, wherein said frequency is determined by examining said LUT.
